(19) United States
(12) Patent Application Publication
(10) Pub. No.: US 2009/0040589 A1
(43) Pub. Date: Feb. 12, 2009

(54) Polymer 4,4'-bipyridinium structures, formulations for an electrochromic active layer, and application therefor

(75) Inventors: Andreas Kanitz, Hochstadt (DE); Wolfgang Roth, Uttenreuth (DE)

Correspondence Address: YOUNG & THOMPSON, 209 Madison Street, Suite 500, ALEXANDRIA, VA, 22314, US

(73) Assignee: SIEMENS AKTIENGESELLSCHAFT, MUNCHEN (DE)

(21) Appl. No.: 11/988,639

(22) PCT Filed: Jul. 10, 2006
(86) PCT No.: PCT/EP2006/064048

§ 371 Date: Apr. 11, 2008

(30) Foreign Application Priority Data
Jul. 11, 2005 (DE) 10 2005 032 316.2

(51) Int. Cl. G02F 1/153; C08G 73/06

(52) U.S. Cl. 359/273; 528/423

(57) ABSTRACT

The invention relates to material systems wherein electrochemical and/or photochemical parallel reactions are completely avoided by stabilising structural modifications, or repressed by orders of magnitude as a result of the structural modifications. The invention also relates to polymer 4,4′-bipyridinium structures, to formulations based on the structures and used for electrochromic active layers, and to the use of 4,4′-bipyridinium structures for producing organic electrochromic displays.

Polymer 4,4′-bipyridinium structures, formulation for an electrochromic active layer, and application therefore

The invention relates to new polymer 4,4′-bipyridinium structures, to formulations based on said structures and used for electrochromic active layers, and to the use of 4,4′-bipyridinium structures for producing organic electrochromic displays.

Electrochromic displays based on organic materials normally include an active electrochromic layer, which in the case of a display is located between electrodes arranged vertically relative to each other. Essential components of the active layer are a redox system and a pH active dye. The concentration ratio of the redox partners relative to each other in the material is changed by the application of a voltage. This reaction causes protons and/or ions to be released or combined in the material, which act on the pH value. If a voltage is applied to the material, the shift in the balance of the redox partners then takes place in the opposite direction at the two electrodes. This means that at the one electrode the pH value increases whereas it reduces at the counter-electrode. The change in the pH value is then converted to a color change in the material by means of a pH dye and the application of the voltage is made visible.

From WO 02/075441A2 and WO 02/075442 A1 it is known that a paste-like formulation, which represents the electrochromic system, is located between the electrodes. The essential components of the composition of this electrochromic system include a polymer as a solid electrolyte, a conductive salt, a redox system, TiO2 as a white pigment, a solvent and a dye. This is usually a pH indicator.

Another principle of implementing electrochromic displays consists not of producing the color change in the display by the change in the pH value but instead by using the redox process that takes place in any case in order to generate a contrast-rich color change by the formation of reductive and/or oxidative states in suitable materials. In this respect, the viologenes and polythiophenes in particular have become known as material classes.

Examples are given in the literature of: M. O. M. Edwards, Appl. Phys. Lett. 2005, 86 (7) and

Helmut W. Heuer, Rolf Wehrmann, Stephan Kirchmeyer Adv. Funct. Mater. 2002, 89.

The most important disadvantage of previous inventions is the relatively low service life of such electrochromic displays. In the case of the pH value-controlled displays (where the charge transport takes place via ions, especially protons) the multiplicity of components in particular is regarded as a disadvantage of the formulation, in fact from the beginning only latent, also additional kinetically or thermodynamically constrained, electrochemical reactions run in parallel, but emerge over time due to the massive deterioration of the contrast. Furthermore a degradation of the transparent electrode can take place due to the proton activity.

With displays based on pure redox materials, such as the viologenic based systems, the color contrast deterioration also occurs particularly due to the Pi (II)— merisation of the reduced species (formation of aromatic stacks through the II electron planes), which leads to a color shift from blue to violet (therefore called viologenic) and also to extremely poor solubility.

In this condition, the pimere species can no longer be fully electrically oxidized (reverted to the colorless condition), so that the contrast in the color change becomes progressively weaker.

The object of this invention is therefore to provide materials for an electrochromic formulation that have an improved long-term stability in the display without further additives (only solvent and pigment).

The object of the invention and the achievement of this object are polymer 4,4′-bipyridinium structures which are separated from each other by an alkaline spacer (C10 to C20), and also their application in a formulation for electrochromic active layers including an electrochromic active layer, which includes at least one component with a 4,4′-bipyridinium structure, with the 4,4′-bipyridinium structure being separated by an alkaline spacer.

A non-conjugated linear C10 to C20 chain that binds the individual bipyridinium units to each other is indicated as the alkaline spacer.

Furthermore, it is essential that the formed polymer only has the improved properties if it is constituted precisely according to the instructions in the exemplary embodiments. Of particular significance is the performance of the reaction at temperatures of 80° C.-120° C., preferably 85° C. (acetonitrile). This ensures that in addition to polymers, oligomers and monofunctionalized 4,4′-pyridinium pyridines are contained in the reaction product.

The following electrochromic formulations, containing at least one component of the following structure, are proposed.

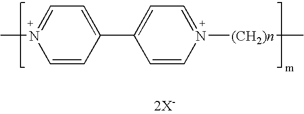

n=10−20;

m=10−200;

X=any anion, preferably halogenide and/or trifluor-methyl-sulfonate.

Furthermore, the material constituted according to the described instructions also contains fractions of monofunctional species. The main fraction of the inventive material consists of structures based on 4,4′-bipyridinium ions that because of the structural properties no longer contain any viologenic properties. In particular, the feature n=10 to 20 has the effect that the probability of a II-merisation occurring due to the formation of aromatic stacks is so low that a uniform reversible reduction over many cycles can be expected. No pimerization occurs for polymers from the known viologenes that are constituted from 4,4′-bipyridinium structures with an alkaline spacer that is smaller than C10. For the non-polymer 4,4′-bipyridinium salts the pimerization occurs anyway, even if not always of equal intensity.

Viologenes are 4,4′-bipyridinium structures that additionally pimerize, which is visible in a hypsochromic color shift (from blue to violet) and characterized by the formulation of a polymer compound with an extremely poor solubility, during reduction. The extremely poor solubility of the pimer causes a residual discoloration of the EC component over time because the reoxidation is no longer 100% reversible. A further disadvantage of such components is the color shift relative to the concentration.

Inventive 4,4′-bipyridinium structures that have no viologenic properties are corresponding polymer 4,4′-bipyridinium structures that are separated from each other by an alkaline spacer (C10 to C20).

The spacer gives the polymer a good solubility in organic solvents and prevents pimerization, so that the 4,4′-bipyridinium units undergo no short-range order due to the stacking. The color of the reduced form remains a stable blue (spectroscopic verification) and the polymer remains highly soluble in the reduced condition in polar and dipolar aprotisic solvents (such as propylene carbonate, butyrolactone, alcohols, glycols). Of particular advantage is the dodecylene spacer that allows no further viologenic properties and still permits a good conductivity of the material.

The fraction of monofunctional 4,4′-pyridinium-pyridine species acts in the inventive formulation as an electron donor and thus brings about the electron transport, and at the same time guarantees this species the anode reaction. Furthermore, the monoalkylation enables a material to be obtained that because of the polarity of the end group produces an improved solubility and thus increased stability of the formulation in the electrochromic cell.

Furthermore, due to the inventive material a pure blue color impression is obtained and not a violet or blue-green color impression as with polymers. Thus the violet color impression is eponymous for this compound class (viologenic).

Surprisingly furthermore formulations can be produced and processed under ambient conditions by using the inventive material.

The use of a formulation containing a polymer 4,4′-bipyridinium salt enables the sharp-edged strongly contrasting depiction of pixels, high switching speed at voltages of less than 1V without the use of a conductive salt, and therefore an improved image reproduction with improved service life.

In this way the inventive 4,4′-bipyridinium salts in the electric field can be cathodically given a blue color and the colorless (white) pyridinium salt can be anodically regenerated.

### EXEMPLARY EMBODIMENTS

### a) Poly-dodecylene 4,4′-bipyridinium-dibromide

0.1 mol 4,4′-bipyridine and 0.1 mol dodecylenedibromide are heated to boiling point for ten hours by stirring in 500 ml of acetonenitrile. After cooling, the reaction mixture is charged with 200 ml of ether and drawn off and then thoroughly washed with ether mixed with 5% methanol. The yield is 95%.

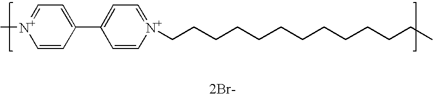

### b) Poly-dodecylene-4,4′-bipyridinium-trifluormethylsulfonate

0.1 mol 4,4′-bipyridine and 0.1 mol dodecylenedibromide are heated to boiling point for ten hours by stirring in 500 ml of acetonenitrile. After cooling, the reaction mixture is charged with 200 ml of ether and drawn off and then thoroughly washed with ether and precipitated by mixing with 5% methanol. The drawn-off product is then dissolved in 100 ml of methanol and treated with a solution of 0.2 mol silver trifluormethylsulfonate in 50 ml of methanol. The silver bromide thus produced is drawn off, the filtrate is concentrated, ether is then added and it is washed. The yield is approximately 75%.

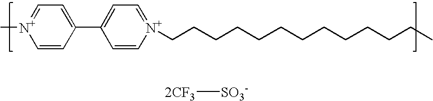

### c) Production of an Electrochromic Formulation

0.6 g of the inventive EC polymer a) is intensively mixed with 6 g TiO2 and 2 g diethyleneglycol in a speed mixer.

### d) Production of an EC Component

The formulation c) is applied between two transparent conductive substrates that can be joined by an adhesive frame. When a d.c. voltage of approximately 1V is applied, the cathode in each case changes color from white to blue.

By means of the invention, material systems are proposed for the first time in which electrochemical and/or photochemical parallel reactions are completely avoided by stabilizing structural modifications, or repressed by orders of magnitude as a result of the structural modifications. The invention relates to polymer 4,4′-bipyridinium structures, to formulations based on said structures and used for electrochromic active layers, and to the use of 4,4′-bipyridinium structures for producing organic electrochromic displays.

1. Polymer 4,4′-bipyridinium structures that are separated from each other by alkaline spacers,
characterized in that
the alkaline spacer includes 10 to 20 carbon atoms.

2. A 4,4′-bipyridinium structure as claimed in claim 1, with the alkaline spacer containing 12 to 16 carbon atoms.

3. A 4,4′-bipyridinium structure as claimed in claim 1, with the alkaline spacer containing 12 carbon atoms.

4. A formulation for an electrochromic active layer,
characterized in that
it includes at least one component with a 4,4′-bipyridinium structure with . . . as claimed in claim 1.

5. An application of a polymer 4,4′ bipyridinium structure with . . . as claimed in claim 1 for producing an electrochromic active layer.

6. An application of a polymer 4,4′ bipyridinium structure . . . as claimed in claim 1 for producing an organic electrochromic display.

7. A 4,4′-bipyridinium structure as claimed in claim 2, with the alkaline spacer containing 12 carbon atoms.

8. A formulation for an electrochromic active layer,
characterized in that
it includes at least one component with a 4,4′-bipyridinium structure with . . . . Claim 2.

9. A formulation for an electrochromic active layer,
characterized in that
it includes at least one component with a 4,4′-bipyridinium structure with . . . . Claim 3.

10. An application of a polymer 4,4′ bipyridinium structure with . . . as claimed in claim 2 for producing an electrochromic active layer.

11. An application of a polymer 4,4′ bipyridinium structure with . . . as claimed in claim 3 for producing an electrochromic active layer.

12. An application of a polymer 4,4′ bipyridinium structure with . . . as claimed in claim 4 for producing an electrochromic active layer.

13. An application of a polymer 4,4′ bipyridinium structure . . . as claimed in claim 2 for producing an organic electrochromic display.

14. An application of a polymer 4,4′ bipyridinium structure . . . as claimed in claim 3 for producing an organic electrochromic display.

15. An application of a polymer 4,4′ bipyridinium structure . . . as claimed in claim 4 for producing an organic electrochromic display.
